(19) United States
(12) Patent Application Publication
(10) Pub. No.: US 2025/0299606 A1
(43) Pub. Date: Sep. 25, 2025

(54) BACK-LIT SIGNAGE SYSTEM

(71) Applicant: AMERICAN LOUVER COMPANY, Des Plaines, IL (US)

(72) Inventor: Daniel Patrick Calby, Park Ridge, IL (US)

(21) Appl. No.: 19/084,632

(22) Filed: Mar. 19, 2025

Related U.S. Application Data
(60) Provisional application No. 63/567,844, filed on Mar. 20, 2024.

(51) Int. Cl. G09F 13/04; F21S 9/03; F21Y 115/10; G09F 13/00

(52) U.S. Cl. CPC G09F 13/0413; F21S 9/03; G09F 13/005; G09F 13/0446; G09F 13/0458; F21Y 2115/10; G09F 13/0463

(57) ABSTRACT

A backlit signage system comprising a sign frame comprising two frame faces rotatably connected via a hinge mechanism, where each of the two frame faces comprises a recessed portion configured to receive a graphic sign, at least one solar panel mounting region configured to receive a solar panel, at least one mounting region configured to removably couple to an electronics enclosure, and at least one LED panel configured to removably couple to each of the two faces of the sign frame, the at least one LED panel being configured to illuminate the graphic sign.

### CROSS-REFERENCE TO RELATED APPLICATIONS

The present application claims the benefit of U.S. Patent Application No. 63/567,844, entitled “BACK-LIT A-FRAME SIGN” filed on 20 Mar. 2024, which is incorporated herein by reference in its entirety.

### FIELD OF INVENTION

The present disclosure relates to illuminated signage systems and, more specifically, to back-lit signage systems designed to offer enhanced durability, functionality, and connectivity features suitable for outdoor advertising applications.

### BACKGROUND

Conventional signage systems, such as A-frame signage systems and vertical signage systems, commonly used for outdoor advertising, often lack the versatility, and technological sophistication required to meet the evolving needs of modern businesses. Existing solutions may suffer from issues such as limited visibility and lighting, hindering their effectiveness in outdoor environments, which can often be poorly illuminated. Along with the challenges of visibility, there exists a need to quickly and easily change the content of signage in order to keep up with changing consumer demands. Because of these shortcomings, there exists a need for an improved back-lit signage system that addresses these challenges while incorporating advanced features to enhance performance and usability.

The present disclosure includes features to address these concerns, including a signage system including a weatherproof LED panel with a diffuser for uniform light distribution, integrated solar charging panels to power the LED panel sustainably, increased mold thickness for enhanced durability, a removable battery and control module for convenient maintenance, and various security measures to deter theft. The signage additionally includes a quick-change feature that allows for quick and easy changes to the content of the signage. Additionally, the signage system incorporates advanced technological capabilities such as light sensing, stackability, smart connectivity (Bluetooth and Wi-Fi), and a USB charging input, making it a versatile and efficient solution for outdoor advertising campaigns.

### SUMMARY

Disclosed herein are approaches for addressing various of the problems and shortcomings of the state of the art, as identified above. More particularly, disclosed herein are backlit signage systems for outdoor advertising applications.

According to a first aspect of the present disclosure, there is provided a backlit signage system comprising a sign frame comprising two frame faces rotatably connected via a hinge mechanism, where each of the two frame faces comprises a recessed portion configured to receive a graphic sign, at least one solar panel mounting region configured to receive a solar panel, at least one mounting region configured to removably couple to an electronics enclosure, and at least one LED panel configured to removably couple to each of the two faces of the sign frame, the at least one LED panel being configured to illuminate the graphic sign.

According to a second aspect of the present disclosure, there is provided a backlit signage system comprising a sign frame comprising at least one frame face, the at least one frame face comprising a top portion and a bottom portion removably coupled to each other, the top portion comprising at least one solar panel including a solar panel wire configured to electrically coupled to at least one LED panel configured to illuminate the graphic sign, the bottom portion comprising a LED panel slot configured to accommodate the at least one LED panel, a recessed portion configured to receive a graphic sign, at least one mounting region configured to removably couple to an electronics enclosure, and a base configured to removably couple to the at least one leg of the sign frame.

### BRIEF DESCRIPTION OF THE DRAWINGS

FIG. 1A shows a perspective view of an exemplary aspect of a backlit signage system.

FIG. 1B shows an exploded view of the exemplary aspect of the backlit signage system of FIG. 1A.

FIG. 1C shows an exemplary schematic with corresponding images of changing of signage in action according to the exemplary aspect of the backlit signage system of FIG. 1A.

FIG. 2A shows a perspective view of an exemplary embodiment of a sign frame according to an aspect of the backlit signage system.

FIG. 2B shows a perspective view of an exemplary embodiment of a sign frame according to an aspect of the backlit signage system.

FIG. 2C shows a perspective view of an exemplary embodiment of a sign frame according to an aspect of the backlit signage system.

FIG. 2D shows an exploded view of the exemplary embodiment of the sign frame of FIG. 2C according to an aspect of the backlit signage system.

FIG. 3A shows a perspective view of an exemplary embodiment of a LED panel according to an aspect of the backlit signage system.

FIG. 3B shows a rear view of the exemplary embodiment of the LED panel of FIG. 3A according to an aspect of the backlit signage system.

FIG. 3C shows a perspective view of an exemplary embodiment of a LED panel according to an aspect of the backlit signage system.

FIG. 3D shows perspective views of an exemplary embodiment of a LED panel according to an aspect of the backlit signage system.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description may include specific details for the purpose of providing a thorough understanding of the subject technology. However, the subject technology is not limited to the specific details set forth herein and may be practiced without these specific details. In some instances, structures and components are shown in block diagram form in order to avoid obscuring the concepts of the subject technology.

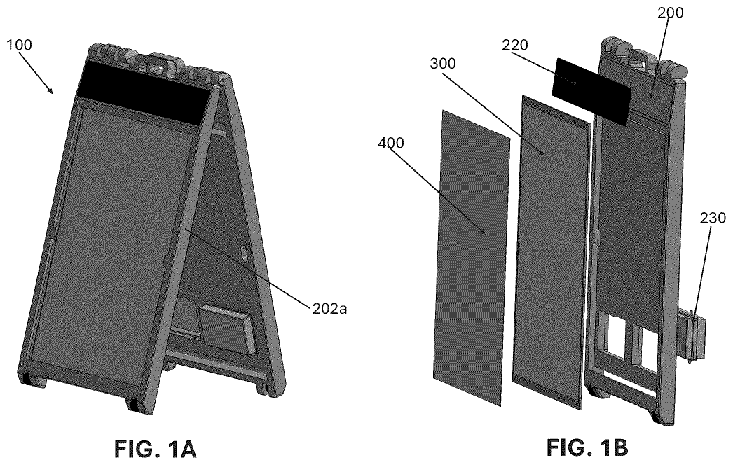

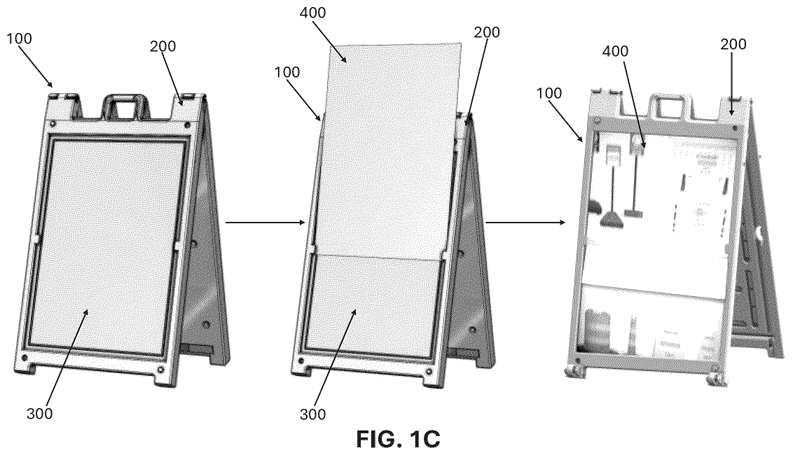

Referring to the drawings, FIGS. 1A and 1B present a perspective view and exploded view of an exemplary aspect of a backlit signage system 100. FIG. 1 also presents the primary structural components of the backlit signage system 100. These include a sign frame 200, a LED panel 300 configured to be coupled to the sign frame 200, at least one solar panel 220 coupled to the sign frame 200, and an electronic enclosure 230 electrically coupled to the sign frame 200. The backlit signage system 100 is configured to receive and securely retain a graphic sign 400 and illuminate it via the LED panel 300. In some aspects, the backlit signage system 100 can be configured to be loaded with a graphic sign 400 made of a clear or translucent material such as acrylic or polycarbonate.

In some aspects of the backlit signage system 100, the LED panel 300 is electrically coupled to be powered by a battery contained within the electronics enclosure 230. In other aspects of the backlit signage system 100, the battery in the electronics enclosure 230 is a rechargeable battery that is electrically coupled to and charged by the solar panel 220 disposed on the sign frame 200. In further aspects of the backlit signage system 100, the electronics enclosure 230 can comprise a programmable control module configured to be programmable by a user to control the operation of the LED panel 300.

To meet the requirements of outdoor use, some aspects of the backlit signage system 100, can be designed to be weatherproof, water-sealed, and/or dust-sealed to protect the internal components from moisture, dust, and other environmental hazards. Some aspects of the backlight signage system 100 can further include light detection sensor configured to activate automatically in low-light conditions, conserving energy and enhancing efficiency. In other aspects, the backlit signage system 100 can be configured to be ultra-violet (UV) stable, such that, the backlit signage system 100 can be placed outside for extended periods of time without degrading in the sun. In further aspects, the backlit signage system 100 can further incorporate various security features including tamper-resistant components and secure locking mechanisms configured to prevent theft. In some aspects, the backlit signage system 100 is configured to be stackable to allow for convenient storage and transportation between locations, optimizing space allocation and reducing logistical costs.

The various aspects of the backlit signage system 100 are configured to ensure that the backlit signage system 100 can meet industry standards for stability, durability, and portability.

FIG. 1C shows an exemplary schematic with corresponding images of changing of signage in action according to the exemplary aspect of the backlit signage system 100 of FIG. 1A. In the left of FIG. 1C, the backlit signage system 100 is in an empty position where the graphic sign 400 has not been removably loaded to the sign frame 200 and has not been illuminated by the LED panel 300. In the center of FIG. 1C, the backlit signage system 100 is shown in an intermediate position during which the graphic sign 400 is being loaded to the sign frame 200 and positioned removably on top of the LED panel 300. In the right of FIG. 1C, the backlit signage system 100 is in a loaded position where the graphic sign 400 has been removable affixed onto the sign frame 200 and is illuminated by the LED panel 300. In this aspect of the backlit signage system 100, the graphic sign 400 is removably loaded onto the sign frame 200 via sliding the graphic sign 400 into slots (further discussed in the sections below) on the sign frame and on top of the LED panel 300. In some aspects, the graphic sign 400 is removably loaded on to the sign frame via at least one of: velcro straps, temporary adhesive, and corner tabs disposed on the sign frame 200.

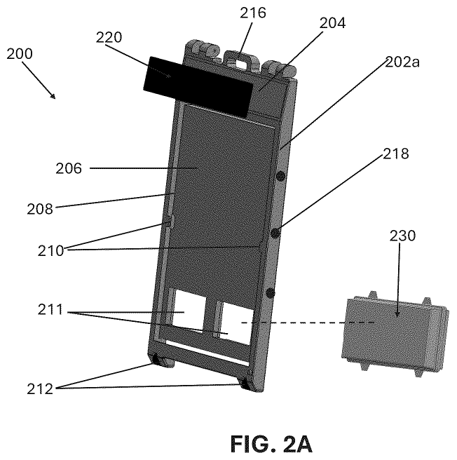

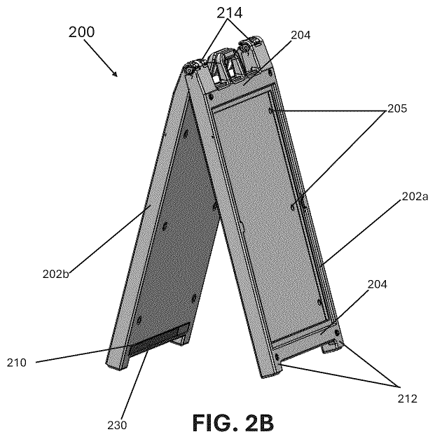

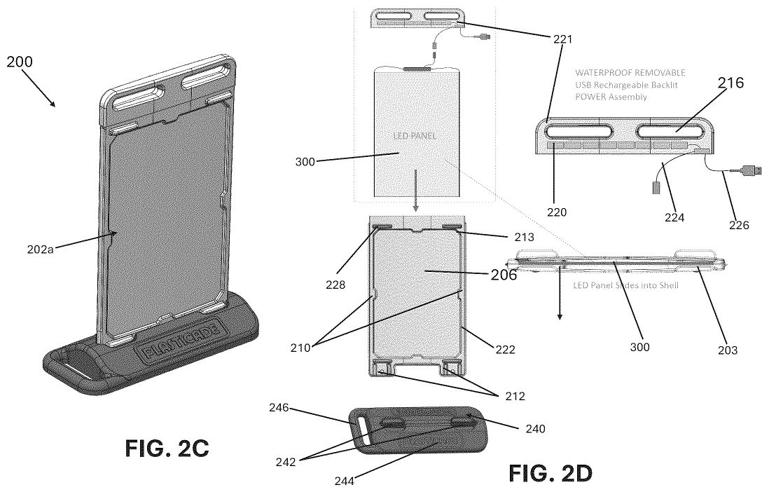

Referring now to FIG. 2A, a perspective view of an exemplary embodiment of a sign frame 200 according to an aspect of the backlit signage system 100 is shown. The sign frame 200 can include at least one frame face 202a comprising at least one solar panel mounting region 204 to couple with a solar panel 220, a recessed portion 206 configured to couple to the LED panel 300 and to load the graphic sign 400, and at least one mounting region 211 configured to couple with the electronics enclosure 230. In some embodiments, such as the embodiment of FIG. 2A, the sign frame 200 can further include at least one leg 212 configured to support the at least one frame face 202a on the floor. In some embodiments, the sign frame 200 can be made of a light weight and durable plastic. In some embodiments, the solar panel 220 can be made of a monocrystalline silicone with ethylene tetrafluoroethylene (ETFE) coating for durability.

In many embodiments, the modular design of sign frame 200 with the at least one mounting region 211 is configured allow for quick battery and electronic enclosure replacement and troubleshooting to minimize downtime and to ensure continuous operation of the backlit signage system 100. In some aspects of the backlit signage system 100, the control module of the electronics module 230 can further comprise smart capabilities such as Bluetooth and Wi-Fi, enabling remote monitoring, control, and content management via compatible devices. In other aspects of the backlit signage system 100, the electronics enclosure 230 can further comprise a USB charging input configured to electrically couple to and receive power from an external power source to power the LED panel 300 of the backlit signage system 100.

In the embodiment presented in FIG. 2A, the at least one frame face 202a further comprises a handle 216 for moving the backlit signage system 100. In some embodiments of the sign frame 200, such as the embodiment of FIG. 2A, the recessed portion 206 can further comprises at least one sliding slot 208 configured to allow the graphic sign 400 to slide into and be loaded onto to the recessed portion 206. In some embodiment, the recessed portion 206 can be configured to removably couple to the graphic sign measuring 24 inches by 36 inches.

In some embodiments, the recession portion 206 can further include at least one retaining tab 210 configured to secure and retain the graphic sign 400 loaded onto the recessed portion 206 of the at least one frame face 202a. In some embodiments, the recession portion 206 can include a plurality of retaining tabs 210 located at various intervals around a perimeter of the recessed portion 206 and configured to secure and retain the graphic sign 400 loaded onto the recessed portion 206 of the at least one frame face 202a. In some embodiments, the plurality of retaining tabs 210 can be located about halfway down the recessed portion 206. In other embodiments, the recessed portion 206 can include at least one of friction fit fasteners, screws, retractable tabs, and hook-and-loop securement methods to retain the loaded graphic sign 400. These options of retaining the graphic sign 400 are configured to also quickly remove/install the graphic sign 400 from the recessed portion 206 in a direction perpendicular to a plane defined by a perimeter of the recessed portion 206. In some embodiments, the at least one frame face 202a can also comprise a plurality of access points 218 configured to allow filling the at least one frame face with a filling agent (e.g., sand) to weigh down and stabilize the at least one frame face 202a on the floor.

Referring now to FIG. 2B, a perspective view of an exemplary embodiment of a sign frame 200 according to an aspect of the backlit signage system 100 is shown. In this embodiment, the sign frame 200 is an A-frame including two frame faces 202a,b rotatably connected to each other via a hinge mechanism 214. The hinge mechanism 214 is configured to allow easy setup of the sign frame 200 and accommodate added weight or accessories without compromising stability.

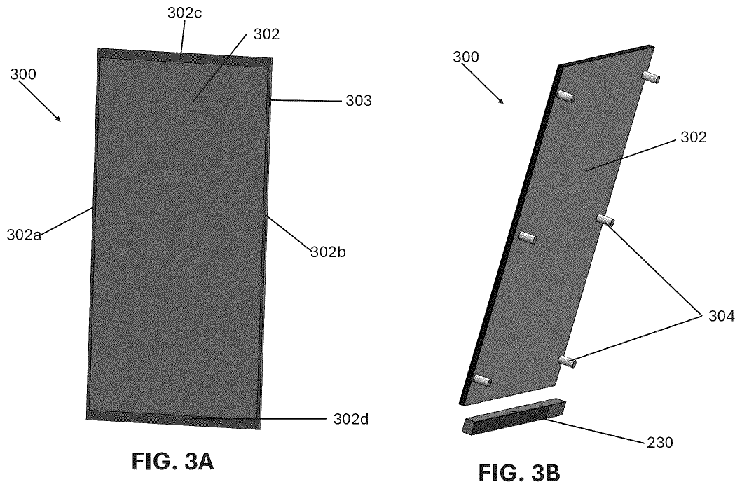

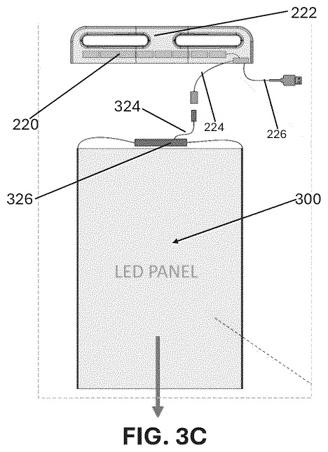

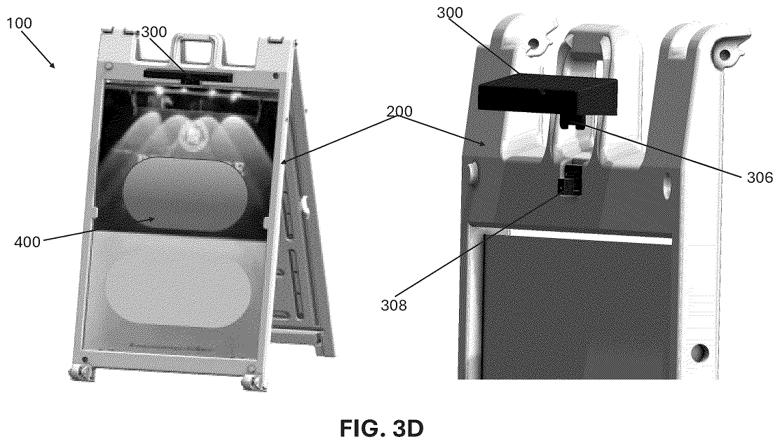

Each of the two frame faces 202a,b comprise two solar panel mounting regions 204 configured to couple with a solar panel 220, a recessed portion 206 configured to couple to the LED panel 300 and to load the graphic sign 400, and at least one mounting region 211 disposed at a bottom region of each of the two frame faces 202a,b configured to receive the electronics enclosure 230 comprising a battery. In some embodiments, such as the embodiment of FIG. 2B, each of the two frame faces 202a,b can include at least one leg 212 configured to support the each of the two frame faces 202a,b on the floor. In this embodiment, one of the two solar panel mounting regions 204 is disposed above the recessed portion 206 and the other of the two solar panel mounting regions 204 is disposed below the recessed portion 206. In some embodiments, each of the two frame faces 202a,b can further comprise a plurality of coupling slots 205 where each of the plurality of the coupling slots 205 are configured to receive a corresponding attachment pole 304 disposed on back of an embodiment of the LED Panel 300 (shown in FIG. 3B) such that the LED panel 300 can be removably coupled to recessed portion 206 of each of the two frame faces 202a,b.

Referring now to FIGS. 2C and 2D, a perspective view and an exploded view of an exemplary embodiment of a sign frame 200 according to an aspect of the backlit signage system 100 are shown. In this embodiment, the sign frame 200 is a vertical frame including a frame face 202a and a base 240 configured to receive the frame face 202a.

In the embodiment presented in FIGS. 2C and 2D, the frame face 202a comprises a top portion 221 and a bottom portion 222 where the top portion 221 and bottom portion 222 are removably connected to each other. The top portion 221 can comprise at least one handle 216 to allow a user to grip and disconnect the top portion 221 from the bottom portion 222. The top portion 221 can also comprise a solar panel 220 including a solar panel wire 224 configured to electrically couple the solar panel 220 with the LED panel 300. In some embodiments, the top portion 221 can also comprise an external connection wire 226, in electrical communication with the solar panel wire 224, configured to connect to the electrical enclosure 230 and to receive power from the electrical enclosure 230 for the LED panel 300 via the solar panel wire 224.

In the embodiment presented in FIGS. 2C and 2D, the bottom portion 222 is removably connected to the top portion 221. The bottom portion 222 can include a LED panel slot 203 configured to accommodate the LED panel. The bottom portion 222 can include translucent material in the recessed portion 206 such that the LED panel 300 can illuminate the graphic sign 400 loaded onto the recessed portion 206. The bottom portion 222 can also include at least one mounting region 211 configured to removably couple to the electrical enclosure 230 (not show in FIGS. 2C and 2D) comprising a battery. In some embodiments, the recession portion 206 of the bottom portion 222 can include a plurality of retaining tabs 210 located at various intervals around the recessed portion 206 and configured to secure and retain the graphic sign 400 loaded onto the recessed portion 206 of the at least one frame face 202a. In some embodiments, the plurality of retaining tabs 210 can be located about halfway down the recessed portion 206 of the bottom portion 222. In other embodiments, the recessed portion 206 can further include at least one corner retractable tab 213 configured to retain the loaded graphic sign 400. The bottom portion 222 can further include at least one leg 212 configured to removably attach to a corresponding leg attachment slot 242 on the base 240 such that the frame face 202a is stabilized vertically to display the graphic sign 400. The bottom portion 222 can further comprise at least one protrusion 228 configured to allow the user to grip and detach the bottom portion 222 from the base 240.

In the embodiment presented in FIGS. 2C and 2D, the frame face 202a is configured to removably attach to a base 240. In some embodiments, the base 240 can comprise at least one corresponding leg attachment slot 242 configured to receive the at least one leg 212 disposed on the frame face 202a. In some embodiments, the at least one leg 212 can comprises a latch configured to clasp with a notch in the at least one corresponding leg attachment slot 242 such that the frame face 202a is locked onto the base 240. The base 240 can comprises at least one base solar panel mounting region 244 configured to couple with a solar panel 220. The base 240 can further comprise at least one handle 246 disposed on the base 240 and configured to allow a user to grip to remove the base 240 from the bottom portion 222.

Referring to the drawings, FIGS. 3A and 3B present a perspective view and a rear view of an exemplary embodiment of a LED panel 300 according to an aspect of the backlit signage system 100. In this embodiment, the LED panel 300 is a rectangular-shaped sheet 302 comprising four sides 302a-d defining a perimeter of the LED panel 300. The LED panel 300 is configured to removably couple with the sign frame. In some embodiments, such as the embodiment of FIGS. 3A and 3B, the sheet 302 of the LED panel 300 comprises at least one attachment pole 304 configured to removably fit into a corresponding coupling slot 205 disposed on the recessed portion 206 of the frame face (refer to FIG. 2B) to secure the LED panel 300 with the sign frame 200.

In some embodiments, the LED panel 300 can comprise an array of individual LEDs, one or more LED strips, or another illumination technique, such as those utilizing light pipes that direct light from one or more light sources to illuminate the graphic sign 400. In some embodiments, the LEDs can be 24V high efficiency LED bulbs. In some embodiments, one or more LED strips are configured around sides 302a-d, such that light emitted from the LEDs is generally directed toward a center of the sheet 302. This configuration is advantageous in that it provides relatively uniform distribution of light across an area of the LED panel 300. In some embodiments, the sheet 302 and/or the sides 302a-d can comprise a diffuser configured to distribute the light emitted from the LEDs uniformly. In some embodiments, the sheet 200 can be printed or embossed with a dot matrix to further diffuse the light from the LEDs. In some embodiments, the LED panel can be configured to have a specified brightness of at least 300 lumens and coupled with a battery in the electronics enclosure 230 with a battery life of at least 8 hours, ensuring optimal performance throughout the day and into the night. In other embodiments, the LED panel can be configured to have a specified brightness of 400 lumens.

Referring to the FIGS. 3A and 3B, in some embodiments, the sheet 302 can be made of an acrylic material. In other embodiments, the sheet can be made of transparent/semi-transparent materials such as glass or semi-transparent plastic. The LED strips can be affixed to the sides 302a-d of the sheet 302 via the use of adhesive tape, caulking, or other methods that provide for weather resistant mechanical securement. The LED panel 300 can be configured to electrically couple to and harness power from the solar panels 220 disposed on the sign frame 200 or base 240. The LED panel 300 can also be configured to electrically couple to and harness power from the battery in the electronic enclosure 230 disposed on the sign frame 200.

Referring to the drawings, FIGS. 3C and 3D present perspective views of alternate exemplary embodiments of the LED panel 300 according to an aspect of the backlit signage system 100. In the embodiment of FIG. 3C, the LED Panel 300 is configured to slide into LED panel slot 203 of the bottom portion 222 of the frame face 202a and electrically coupled to the solar panel 224 wire disposed in the top portion 221. In this embodiment, the LED panel 300 can receive power from the solar panel 220 and/or electronics enclosure 230 via the solar panel wire 224 and/or the external connection wire 226. The LED panel can comprise a power junction 326 electrically coupled to the LEDs and configured to receive the power from the solar panel wire 224 and power the LEDs of the LED panel 300.

In the embodiment of FIG. 3D, the LED Panel 300 is configured to be removably front mounted to the sign frame 200 such that the LEDs are positioned above the graphic sign 400 loaded onto the sign frame 200. The front mounted LED panel is configured to evenly spread light across the loaded graphic sign 400, enhancing the visibility of the advertising message in various lighting conditions. In some embodiments, the LED panel 300 can comprise an attachment 306 configured to be removably coupled, without need for screws or fasteners, to a LED panel hook 308 disposed on the sign frame 200 above the recessed portion 206. In the embodiment of the front mounted LED panel 300 in FIG. 3D, the LED panel 300 can comprise a solar panel 220 configured to receive sunlight and power the LED panel 300. In some embodiments, the front mounted LED panel 300 in FIG. 3D can comprise a USB charging port configured to charge the LED panel 300.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously. The accompanying method claims, if any, present elements of the various steps, operations or processes in a sample order, and are not meant to be limited to the specific order or hierarchy presented. These may be performed in serial, linearly, in parallel or in different order. It may be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout the disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary aspects, the functions described may be implemented in hardware, software, firmware, or any combination thereof. If implemented in software, the functions may be stored as one or more instructions or code on a non-transitory computer-readable medium or non-transitory processor-readable medium. The steps of a method or algorithm disclosed herein may be embodied in a processor-executable software module which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim.

What is claimed is:

1. A backlit signage system comprising:
a sign frame comprising two frame faces rotatably connected via a hinge mechanism, wherein each of the two frame faces comprises:
a recessed portion configured to receive a graphic sign;
at least one solar panel mounting region configured to receive a solar panel;
at least one mounting region configured to removably couple to an electronics enclosure; and
at least one LED panel configured to removably couple to each of the two faces of the sign frame, the at least one LED panel being configured to illuminate the graphic sign.

2. The backlit signage system of claim 1, wherein the at least one LED panel is configured to removably couple to the recessed portion of the each of the two frame faces.

3. The backlit signage system of claim 2, wherein the at least one LED panel is positioned under the graphic sign loaded onto the recessed portion of the each of the two frame faces.

4. The backlit signage system of claim 3, wherein the at least one LED panel is electrically coupled to at least one of: the at least one solar panel and the electronics enclosure.

5. The backlit signage system of claim 4, wherein the electronics enclosure comprises:
a programmable control module configured to control an operation of the at least one LED panel; and
a battery configured to supply power to the at least one LED panel.

6. The backlit signage system of claim 1, wherein the electronics enclosure further comprises at least one leg disposed on each of the two frame faces.

7. The backlit signage system of claim 1, wherein the recessed portion comprises at least one sliding slot configured allow the graphic sign to slide into and be loaded onto the recessed portion.

8. The backlit signage system of claim 7, wherein the recessed portion further comprises a plurality of retaining tabs disposed around a perimeter of the recessed portion, the plurality of retaining tabs configured to retain the graphic sign loaded onto the recessed portion.

9. The backlit signage system of claim 8, wherein the recessed portion further comprises at least one of friction fit fasteners, screws, retractable tabs, and hook-and-loop securement methods configured to retain the graphic sign loaded onto the recessed portion.

10. The backlit signage system of claim 1, where the at least one LED panel comprises:
a sheet comprising four sides defining a perimeter of the LED panel; and
at least one LED strip disposed on the sheet and configured to illuminate the graphic sign.

11. The backlit signage system of claim 10, wherein the at least one LED strip is disposed on at least one of the four sides defining the perimeter of the LED panel.

12. The backlit signage system of claim 11, wherein the at least one LED panel further comprises a diffuser configured to uniformly distribute the light emitted from the at least one LED strip.

13. The backlit signage system of claim 12, wherein the sheet further comprises a dot matrix configured to uniformly distribute the light emitted from the at least one LED strip.

14. The backlit signage system of claim 1, wherein the at least LED panel can be configured to have a specific brightness of at least 300 lumens.

15. The backlit signage system of claim 1, wherein each of the two frame faces of the sign frame comprises a plurality of access points configured to allow filling the sign frame with a filling agent.

16. A backlit signage system comprising:
a sign frame comprising at least one frame face, the at least one frame face comprising:
a top portion and a bottom portion removably coupled to each other, the top portion comprising:
at least one solar panel including a solar panel wire configured to electrically coupled to at least one LED panel configured to illuminate the graphic sign;
the bottom portion comprising:
a LED panel slot configured to accommodate the at least one LED panel;
a recessed portion configured to receive a graphic sign;
at least one mounting region configured to removably couple to an electronics enclosure; and
a base configured to removably couple to the sign frame.

17. The backlit signage system of claim 16, wherein base comprises:
at least one base solar panel mounting region configured to couple with the at least one solar panel; and
at least one handle configured to allow a user to grip and remove the base from the bottom portion.

18. The backlit signage system of claim 16, further comprising a front mounted LED panel configured to couple to the sign frame, wherein the front mounted LED panel is positioned above the recessed portion.

19. The backlit signage system of claim 16, wherein the electronics enclosure comprises:
a programmable control module configured to control an operation of the at least one LED panel; and
a battery configured to supply power to the at least one LED panel.

20. The backlit signage system of claim 16, wherein the at least LED panel can be configured to have a specific brightness of at least 300 lumens.
